(19) United States
(12) Patent Application Publication
(10) Pub. No.: US 2026/0225528 A1
(43) Pub. Date: Aug. 6, 2026

(54) SYSTEMS AND METHODS FOR MONITORING DIGITAL MIRROR DISPLAYS OF A VEHICLE

(71) Applicant: GM GLOBAL TECHNOLOGY OPERATIONS LLC, Detroit, MI (US)

(72) Inventors: Jonglee Park, Novi, MI (US); Julien P. Mourou, Bloomfield Hills, MI (US); Charles R. Quinn, Pleasant Ridge, MI (US); Manoj Kumar Sharma, Troy, MI (US)

(73) Assignee: GM GLOBAL TECHNOLOGY OPERATIONS LLC, Detroit, MI (US)

(21) Appl. No.: 19/024,357

(22) Filed: Jan. 16, 2025

(51) Int. Cl. B60R 1/26; G06T 5/60; G06T 7/11

(52) U.S. Cl. CPC B60R 1/26; G06T 5/60; G06T 7/11; B60R 2300/30; B60R 2300/50; G06T 2207/20084; G06T 2207/30252

(57) ABSTRACT

An external image is captured by a first camera system of a vehicle. The external image includes a perspective of a vehicle mirror view of an external environment outside of the vehicle. An internal image is captured by a second camera system of the vehicle. The internal image includes an in-cabin environment inside the vehicle. The internal image includes an image of a digital mirror display inside the vehicle. The digital mirror display is generated based on the external image. A determination is made regarding whether the external image matches the image of the digital mirror display. An image mismatch notification is generated for display on a vehicle display device of the vehicle based on the determination.

### INTRODUCTION

The technical field generally relates to vehicles, and more particularly relates to systems and methods for monitoring digital mirror displays of a vehicle.

Many vehicles include one or more digital mirror display devices. Examples of digital mirror display devices includes a left side view digital mirror display device and a right side view digital mirror display device. External vehicle cameras capture images of an environment outside the vehicle from a perspective of a left side view mirror and a right side view mirror. The images from the perspective of the left side view mirror are displayed on the left side view digital mirror display device as left side view digital mirror displays and the images from the perspective of the right side view mirror are displayed on the right side view digital mirror display device as right side view digital mirror displays.

Accordingly, it is desirable to provide systems and methods for monitoring digital mirror displays of a vehicle. Other desirable features and characteristics will become apparent from the subsequent detailed description and the appended claims, taken in conjunction with the accompanying drawings and the foregoing technical field and background.

### SUMMARY

A digital mirror display monitoring system for a vehicle includes at least one processor and at least one memory communicatively coupled to the at least one processor. The at least one memory includes instructions that upon execution by the at least one processor, causes the at least one processor to: receive an external image captured by a first camera system of the vehicle, the external image including a perspective of a vehicle mirror view of an external environment outside of the vehicle; receive an internal image captured by a second camera system of the vehicle, the internal image including an in-cabin environment inside the vehicle, wherein the internal image includes an image of a digital mirror display inside the vehicle and the digital mirror display is generated based on the external image; determine whether the external image matches the image of the digital mirror display; and generate an image mismatch notification for display on a vehicle display device of the vehicle based on the determination.

In at least one embodiment, the at least one memory further includes instructions that upon execution by the at least one processor, causes the at least one processor to: crop the internal image to generate a region of interest (ROI) of the internal image associated with the image of the digital mirror display; implement distortion correction of the ROI of the internal image to generate a corrected image of the digital mirror display; and determine whether the external image matches the image of the digital mirror display based on a comparison of the external image with the corrected image of the digital mirror display.

In at least one embodiment, the at least one memory further includes instructions that upon execution by the at least one processor, causes the at least one processor to use a trained deep neural network (DNN) model to: generate a first set of features based on the external image; generate a first vector based on the first set of features; generate a second set of features based on the corrected image of the digital mirror display; generate a second vector based on the second set of features; and determine whether the external image matches the corrected image of the digital mirror display based on a comparison of the first vector to the second vector.

In at least one embodiment, the DNN is classifier DNN.

In at least one embodiment, the at least one memory further includes instructions that upon execution by the at least one processor, causes the at least one processor to upon a determination that the external image does not match the image of the digital mirror display, identify an image mismatch cause associated with the digital mirror display, the image mismatch cause being one of a digital mirror display freeze, a digital mirror display color fade, and black pixel detection in the digital mirror display.

In at least one embodiment, the at least one memory further includes instructions that upon execution by the at least one processor, causes the at least one processor to upon a determination that the external image does not match the image of the digital mirror display, transmit the external image to an infotainment display device of the vehicle for display on the infotainment display device.

In at least one embodiment, the at least one memory further includes instructions that upon execution by the at least one processor, causes the at least one processor to: reboot a digital mirror display device configured to display the digital mirror display; determine whether the reboot of the digital mirror display device resulted in the external image matching the image of the digital mirror display; and issue a command to the infotainment display device to cease display of the external image on the infotainment vehicle display device based on the determination.

In at least one embodiment, the at least one memory further includes instructions that upon execution by the at least one processor, causes the at least one processor to upon a determination that the reboot of the digital mirror display device did not result in the external image matching the image of the digital mirror display, issue a command to shut down the digital mirror display device.

In at least one embodiment, the digital mirror display device is a side view digital mirror display device of the vehicle.

In at least one embodiment, the at least one memory further includes instructions that upon execution by the at least one processor, causes the at least one processor to: modify at least one color in the external image in accordance with a color deficient driver setting to generate a modified external image; issue a command to a digital mirror display device to display the digital mirror display based on the modified external image; determine whether the modified external image matches the image of the digital mirror display; and generate the digital mirror display device mismatch notification for display on the vehicle display device based on the determination.

A method of monitoring a digital mirror display including: receiving, at a controller, an external image captured by a first camera system of the vehicle, the external image including a perspective of a vehicle mirror view of an external environment outside of the vehicle; receiving, at the controller, an internal image captured by a second camera system of the vehicle, the internal image including an in-cabin environment inside the vehicle, wherein the internal image includes an image of a digital mirror display inside the vehicle and the digital mirror display is generated based on the external image; determining, by the controller, whether the external image matches the image of the digital mirror display; and generating, by the controller, an image mismatch notification for display on a vehicle display device of the vehicle based on the determination.

In at least one embodiment, the method further includes: cropping, by the controller, the internal image to generate a region of interest (ROI) of the internal image associated with the image of the digital mirror display; implementing, by the controller, distortion correction of the ROI of the internal image to generate a corrected image of the digital mirror display; and determining, by the controller, whether the external image matches the image of the digital mirror display based on a comparison of the external image with the corrected image of the digital mirror display.

In at least one embodiment, the method further includes: using, by the controller, a trained deep neural network (DNN) model to: generate a first set of features based on the external image; generate a first vector based on the first set of features; generate a second set of features based on the corrected image of the digital mirror display; generate a second vector based on the second set of features; and determine whether the external image matches the corrected image of the digital mirror display based on a comparison of the first vector to the second vector.

In at least one embodiment, the method further includes upon a determination that the external image does not match the image of the digital mirror display, identifying, by the controller, an image mismatch cause associated with the digital mirror display, the image mismatch cause being one of a digital mirror display freeze, a digital mirror display color fade, and black pixel detection in the digital mirror display.

In at least one embodiment, the method further includes upon a determination that the external image does not match the image of the digital mirror display, transmitting, by the controller, the external image to an infotainment display device of the vehicle for display on the infotainment display device.

In at least one embodiment, the method further includes: rebooting, by the controller, a digital mirror display device configured to display the digital mirror display; determining, by the controller, whether the reboot of the digital mirror display device resulted in the external image matching the image of the digital mirror display; and issuing a command, by the controller, to the infotainment display device to cease display of the external image on the infotainment vehicle display device based on the determination.

In at least one embodiment, the method further includes upon a determination that the reboot of the digital mirror display device did not result in the external image matching the image of the digital mirror display, issuing, by the controller, a command to shut down the digital mirror display device.

In at least one embodiment, the digital mirror display device is a side view digital mirror display device of the vehicle.

In at least one embodiment, the method further includes: modifying, by the controller, at least one color in the external image in accordance with a color deficient driver setting to generate a modified external image; issuing a command, by the controller, to a digital mirror display device to display the digital mirror display based on the modified external image; determining, by the controller, whether the modified external image matches the image of the digital mirror display; and generating, by the controller, the digital mirror display device mismatch notification for display on the vehicle display device based on the determination.

A vehicle including a digital mirror display monitoring system includes at least one processor and at least one memory communicatively coupled to the at least one processor. The at least one memory includes instructions that upon execution by the at least one processor, causes the at least one processor to: receive an external image captured by a first camera system of the vehicle, the external image including a perspective of a vehicle mirror view of an external environment outside of the vehicle; receive an internal image captured by a second camera system of the vehicle, the internal image including an in-cabin environment inside the vehicle, wherein the internal image includes an image of a digital mirror display inside the vehicle and the digital mirror display is generated based on the external image; determine whether the external image matches the image of the digital mirror display; and generate an image mismatch notification for display on a vehicle display device of the vehicle based on the determination.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle including a digital mirror display monitoring system in accordance with at least one embodiment;

FIG. 2 is a functional block diagram of a controller including a digital mirror display monitoring system in accordance with at least one embodiment;

FIG. 3 is a diagrammatic representation of a top view of an exemplary vehicle configured to implement a digital mirror display monitoring system in accordance with at least one embodiment; and

FIG. 4 is a flowchart representation of an exemplary method of monitoring a digital mirror display in accordance with at least one embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

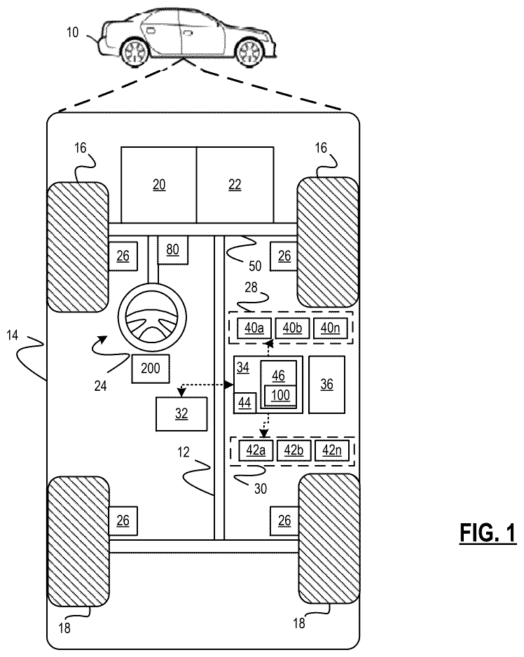

Referring to FIG. 1, a functional block diagram of a vehicle 10 including a digital mirror display monitoring system 100 in accordance with at least one embodiment is shown. The vehicle 10 generally includes a chassis 12, a body 14, front wheels 16, and rear wheels 18. While the vehicle 10 is depicted in the illustrated embodiment as a passenger car, the vehicle 10 may be other types of vehicles including trucks, sport utility vehicles (SUVs), and recreational vehicles (RVs).

In various embodiments, the body 14 is arranged on the chassis 12 and substantially encloses components of the vehicle 10. The body 14 and the chassis 12 may jointly form a frame. The wheels 16, 18 are each rotationally coupled to the chassis 12 near a respective corner of the body 14.

In various embodiments, the vehicle 10 is an autonomous or semi-autonomous vehicle that is automatically controlled to carry passengers and/or cargo from one place to another. For example, in an exemplary embodiment, the vehicle 10 is a so-called Level Two, Level Three, Level Four or Level Five automation system. Level two automation means the vehicle assists the driver in various driving tasks with driver supervision. Level three automation means the vehicle can take over all driving functions under certain circumstances. All major functions are automated, including braking, steering, and acceleration. At this level, the driver can fully disengage until the vehicle tells the driver otherwise. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the vehicle 10 generally includes a propulsion system 20 a transmission system 22, a steering system 24, a braking system 26, a sensor system 28, an actuator system 30, at least one data storage device 32, at least one controller 34, and a communication system 36. The controller 34 is configured to implement an automated driving system (ADS). The propulsion system 20 is configured to generate power to propel the vehicle. The propulsion system 20 includes an internal combustion engine (ICE). The propulsion system 20 may, in various embodiments, also include an electric machine such as a traction motor, a fuel cell propulsion system, and/or any other type of propulsion configuration. The transmission system 22 is configured to transmit power from the propulsion system 20 to the vehicle wheels 16, 18 according to selectable speed ratios. According to various embodiments, the transmission system 22 may include a step-ratio automatic transmission, a continuously-variable transmission, or other appropriate transmission. The braking system 26 is configured to provide braking torque to the vehicle wheels 16, 18. The braking system 26 may, in various embodiments, include friction brakes, brake by wire, a regenerative braking system such as an electric machine, and/or other appropriate braking systems.

The steering system 24 is configured to influence a position of the of the vehicle wheels 16. While depicted as including a steering wheel and steering column, for illustrative purposes, in some embodiments contemplated within the scope of the present disclosure, the steering system 24 may not include a steering wheel and/or steering column. The steering system 24 includes a steering column coupled to an axle 50 associated with the front wheels 16 through, for example, a rack and pinion or other mechanism (not shown). Alternatively, the steering system 24 may include a steer by wire system that includes actuators associated with each of the front wheels 16.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, a steering wheel sensor, and/or other sensors.

The vehicle dynamics sensors provide vehicle dynamics data including longitudinal speed, yaw rate, lateral acceleration, longitudinal acceleration, etc. The vehicle dynamics sensors may include wheel sensors that measure information pertaining to one or more wheels of the vehicle 10. In one embodiment, the wheel sensors comprise wheel speed sensors that are coupled to each of the wheels 16, 18 of the vehicle 10. Further, the vehicle dynamics sensors may include one or more accelerometers (provided as part of an Inertial Measurement Unit (IMU)) that measure information pertaining to an acceleration of the vehicle 10. In various embodiments, the accelerometers measure one or more acceleration values for the vehicle 10, including latitudinal and longitudinal acceleration and yaw rate. In at least one embodiment, the vehicle dynamic sensors provide vehicle location and vehicle movement data.

The actuator system 30 includes one or more actuator devices 42a-42n that control one or more vehicle features such as, but not limited to, one or more vehicle wheels 16, 18 the propulsion system 20, the transmission system 22, the steering system 24, and the braking system 26. In various embodiments, the vehicle features can further include interior and/or exterior vehicle features such as, but are not limited to, doors, a trunk, and cabin features such as air, music, lighting, etc. (not numbered).

The communication system 36 is configured to wirelessly communicate information to and from other entities 48, such as but not limited to, other vehicles (vehicle to vehicle, “V2V” communication,) infrastructure (vehicle to infrastructure “V2I” communication), remote systems, and/or personal devices. In an exemplary embodiment, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in the ADS of the vehicle 10. In various embodiments, the data storage device 32 stores defined maps of the navigable environment. In various embodiments, the defined maps may be predefined by and obtained from a remote system. For example, the defined maps may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10. In at least one embodiment, the computer-readable storage device 46 is at least one memory configured to store the digital mirror display monitoring system 100.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10. In various embodiments, the controller(s) 34 are configured to implement ADS.

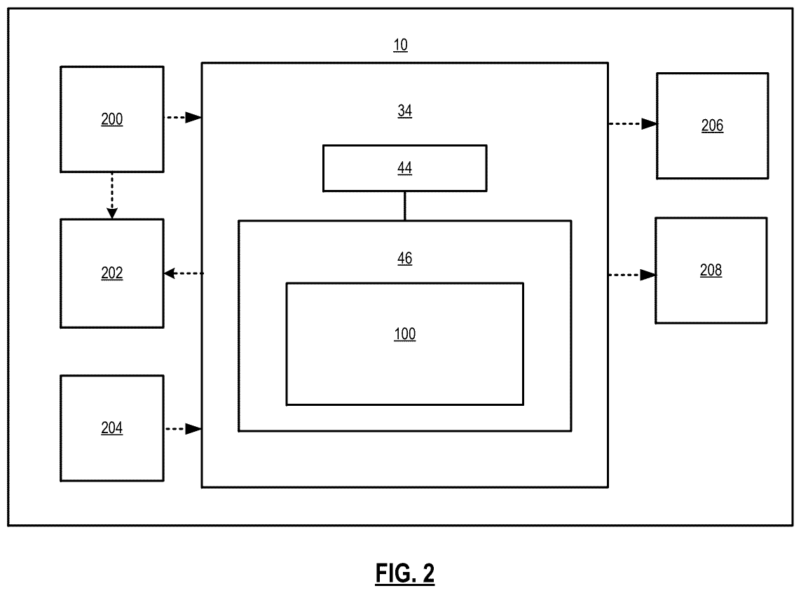

Referring to FIG. 2, a functional block diagram of a controller 34 including a digital mirror display monitoring system 100 in accordance with at least one embodiment is shown. The controller 34 includes at least one processor 44 and at least one memory 46. The at least one processor 44 is a programable device that includes one or more instructions stored in or associated with the at least one memory 46. The at least one memory 46 includes instructions that the at least one processor 44 is configured to execute. The at least one memory 46 includes an embodiment of the digital mirror display monitoring system 100.

The controller 34 is configured to be communicatively coupled to one or more external cameras 200, one or more digital mirror display devices 202, one or more internal cameras 204, a vehicle display device 206, and an infotainment display device 208. Each external camera 200 is configured to be communicatively coupled to an associated digital mirror display device 202. In at least one embodiment, the external camaras 200 are disposed outside of the vehicle 10. In at least one embodiment, the external camaras 200 are disposed inside the vehicle 10.

Each digital mirror display device 202 is configured to display digital mirror displays that represent an associated vehicle mirror view. Each external camera 200 is configured to capture external images of an environment outside the vehicle 10 from the perspective of a vehicle mirror view. Each external camera 200 is configured to transmit the captured external images to an associated digital mirror display device 202. Each digital mirror display device 202 is configured to display the received external images that represent the environment outside of the vehicle 10 from the perspective of the associated vehicle mirror view as digital mirror displays.

The internal camera(s) 206 is configured to capture internal images of an in-cabin environment inside the vehicle 10. The internal images include images of the digital mirror displays displayed on the digital mirror display devices 202. The digital mirror display monitoring system 100 is configured to receive the external images captured by the external cameras 200 and the internal images captured by the internal camera(s) 206.

The digital mirror display monitoring system 100 is configured to determine whether the external images captured by an external camera 200 matches the images of the digital mirror displays on a digital mirror display device 202 associated with the external camera 200. If the digital mirror display monitoring system 100 determines that the external images captured by the external camera 200 do not match the images of the digital mirror displays on the digital mirror display device 202 associated with the external camera 200, the digital mirror display monitoring system 100 is configured to generate an image mismatch notification for display on a vehicle display device 206 of the vehicle 10. A mismatch between an external image captured by an external camera 200 associated with a digital mirror display device 202 and an image of a digital mirror display displayed on the digital mirror display device 202 in an internal image captured by an internal camera 204 is indicative of a digital mirror display device 202 display issue. In at least one embodiment, the image mismatch notification identifies the specific digital mirror display device 202 associated with the image mismatch. In at least one embodiment, the digital mirror display monitoring system 100 is configured to transmit the external images associated with the digital mirror display device 202 experiencing the image mismatch to an infotainment display device 208 of the vehicle 10 for display on the infotainment display device 208.

The controller 34 may include additional components that facilitate operation of the digital mirror display monitoring system 100. The operation of the digital mirror display monitoring system 100 will be described in greater detail below.

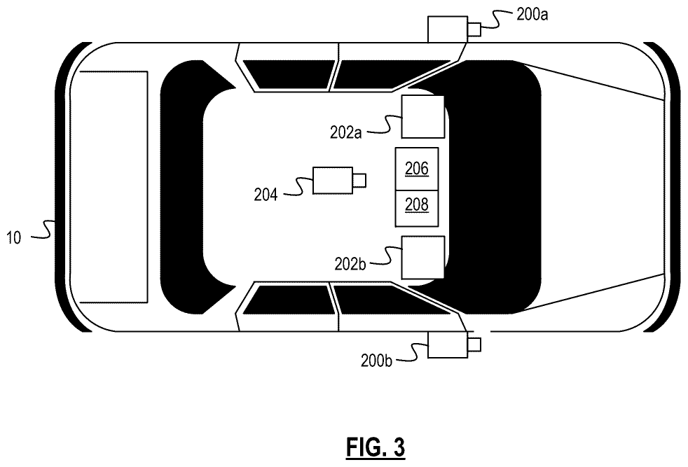

Referring to FIG. 3, a diagrammatic representation of a top view of an exemplary vehicle 10 configured to implement a digital mirror display monitoring system 100 in accordance with at least one embodiment is shown. The vehicle 10 includes a first external camera 200a, a second external camera 200b, a first digital mirror display device 202a, a second digital mirror display device 202b, an internal camera 204 a vehicle display device 206, and an infotainment display device 208. The first digital mirror display device 202a is a left side view digital mirror display device and the second digital mirror display device 202b is a right side view digital mirror display device. The first external camera 200a is associated with the first digital mirror display device 202a and the second external camera 200b is associated with the second digital mirror display device 202b.

The first external camera 200a associated with the first digital mirror display device 202a (the left side view digital mirror display device) is configured to capture external images of the environment outside the vehicle 10 from a perspective of a left side view mirror of the vehicle 10. The external images of the environment outside the vehicle 10 from the perspective of the left side view mirror of the vehicle 10 are displayed by the first digital mirror display device 202a (the left side view digital mirror display device) as left side view digital mirror displays in real time. The digital mirror display monitoring system 100 is configured to receive the external images of the environment outside the vehicle 10 from the perspective of the left side view mirror of the vehicle 10 from the first external camera 200a associated with the first digital mirror display device 202a (the left side view digital mirror display device) in real time.

The second external camera 200b associated with the second digital mirror display device 202b (the right side view digital mirror display device) is configured to capture external images of the environment outside the vehicle 10 from a perspective of a right side view mirror of the vehicle 10. The external images of the environment outside the vehicle 10 from the perspective of the right side view mirror of the vehicle 10 are displayed by the second digital mirror display device 202b (the right side view digital mirror display device) as right side view digital mirror displays in real time. The digital mirror display monitoring system 100 is configured to receive the external images of the environment outside the vehicle 10 from the perspective of the right side view mirror of the vehicle 10 from the second external camera 200b associated with the second digital mirror display device 202b (the right side view digital mirror display device) in real time.

The internal camera 204 is configured to capture internal images of an in-cabin environment inside the vehicle 10. The internal images include images of the digital mirror displays displayed on the first digital mirror display device 202a (the left side view digital mirror display device) and the second digital mirror display device 202b (the right side view digital mirror display device). The digital mirror display monitoring system 100 is configured to receive the internal images captured by the internal camera 204 in real time. In at least one embodiment, the internal images captured by the internal camera 204 are wide field of view (FoV) images of the in-cabin environment.

In at least one embodiment, the digital mirror display monitoring system 100 is configured to crop each internal image to generate a first region of interest (ROI) and a second ROI. The first ROI is an image of the left side view digital mirror display displayed on the first digital mirror display device 202a (the left side view digital mirror display device). The second ROI is an image of the right side view digital mirror display displayed on the second digital mirror display device 202b (the right side view digital mirror display device).

In at least one embodiment, the digital mirror display monitoring system 100 is configured to implement distortion correction of the first ROI to generate a corrected image of the left side view digital mirror display displayed on the first digital mirror display device 202a (the left side view digital mirror display device). The digital mirror display monitoring system 100 is configured to implement distortion correction of the second ROI to generate a corrected image of the right side view digital mirror display displayed on the second digital mirror display device 202b (the right side view digital mirror display device).

The digital mirror display monitoring system 100 is configured to determine whether the external images received from the first external camera 200a match the corrected images of the left side view digital mirror displays displayed on the first digital mirror display device 202a (the left side view digital mirror display device) in real time. The digital mirror display monitoring system 100 is configured to determine whether the external images received from the second external camera 200b match the corrected images of the right side view digital mirror displays displayed on the second digital mirror display device 202b (the right side view digital mirror display device) in real time.

In at least one embodiment, the digital mirror display monitoring system 100 is configured to use a trained deep neural network (DNN) model to compare the external images received from the first external camera 200a to the corrected images of the left side view digital mirror displays displayed on the first digital mirror display device 202a (the left side view digital mirror display device) and the external images received from the second external camera 200b to the corrected images of the right side view digital mirror displays displayed on the second digital mirror display device 202b (the right side view digital mirror display device) in real time. In at least one embodiment, the trained DNN model is a trained DNN classifier model.

If the digital mirror display monitoring system 100 determines that an external image captured by the first external camera 200a does not match a corrected image of a left side view digital mirror display displayed on the first digital mirror display device 202a (the left side view digital mirror display device) the digital mirror display monitoring system 100 is configured to generate an image mismatch notification for display on the vehicle display device 206 indicating that there is a display issue associated with the first digital mirror display device 202a (the left side view digital mirror display device). The image mismatch notification identifies the first digital mirror display device 202a (the left side view digital mirror display device) as the one associated with the image mismatch. The digital mirror display monitoring system 100 is configured to transmit the external images associated with the first digital mirror display device 202a (the left side view digital mirror display device) to the infotainment display device 208 for display on the infotainment display device 208. In at least one embodiment, the digital mirror display monitoring system 100 is configured to identify a cause associated with the image mismatch associated with the first digital mirror display device 202a (the left side view digital mirror display device). Examples of causes include, but are not limited to a digital mirror display freeze, a digital mirror display color fade, black pixel detection, and a time delay between the image captured by the external camera and the image captured by the internal camera in the digital mirror display.

The digital mirror display monitoring system 100 is configured to reboot the first digital mirror display device 202a (the left side view digital mirror display device) and determine whether the reboot of the first digital mirror display device 202a (the left side view digital mirror display device) resulted in an external image of captured by the first external camera 200a matching a display of a corrected image of a left side view digital mirror display displayed on the first digital mirror display device 202a (the left side view digital mirror display device).

If the digital mirror display monitoring system 100 determines that the reboot of the first digital mirror display device 202a (the left side view digital mirror display device) resulted in an external image captured by the first external camera 200a matching a display of a corrected image of a left side view digital mirror display displayed on the first digital mirror display device 202a (the left side view digital mirror display device), the digital mirror display monitoring system 100 issues a command to the infotainment display device 208 to cease display of the external images associated with the first digital mirror display device 202a (the left side view digital mirror display device) on the infotainment display device 208. In at least one embodiment, in the case of a successful reboot, the infotainment display device 208 displays an issue resolved notification.

If the digital mirror display monitoring system 100 determines that the reboot of the first digital mirror display device 202a (the left side view digital mirror display device) did not result in an external image of captured by the first external camera 200a matching a display of a corrected image of a left side view digital mirror display displayed on the first digital mirror display device 202a (the left side view digital mirror display device), the digital mirror display monitoring system 100 issues a command to shut down the first digital mirror display device 202a (the left side view digital mirror display device). The first digital mirror display device 202a shuts down in response to the command to shut down the first digital mirror display device 202a (the left side view digital mirror display device). In at least one embodiment, in the case of an unsuccessful reboot, the infotainment display device 208 displays a rear view monitor system needs service notification.

If the digital mirror display monitoring system 100 determines that an external image captured by the second external camera 200b does not match a corrected image of a right side view digital mirror display displayed on the second digital mirror display device 202b (the right side view digital mirror display device) the digital mirror display monitoring system 100 is configured to generate an image mismatch notification for display on the vehicle display device 206 indicating that there is a display issue associated with the second digital mirror display device 202b (the right side view digital mirror display device). The image mismatch notification identifies the second digital mirror display device 202b (the right side view digital mirror display device) as the one associated with the image mismatch. The digital mirror display monitoring system 100 is configured to transmit the external images associated with the second digital mirror display device 202b (the right side view digital mirror display device) to the infotainment display device 208 for display on the infotainment display device 208.

The digital mirror display monitoring system 100 is configured to reboot the second digital mirror display device 202b (the right side view digital mirror display device) and determine whether the reboot of the second digital mirror display device 202b (the right side view digital mirror display device) resulted in an external image of captured by the second external camera 200b (the right side view digital mirror display device) matching a display of a corrected image of a right side view digital mirror display displayed on the second digital mirror display device 202b (the right side view digital mirror display device).

If the digital mirror display monitoring system 100 determines that the reboot of the second digital mirror display device 202b (the right side view digital mirror display device) resulted in an external image of captured by the second external camera 200b matching a display of a corrected image of a right side view digital mirror display displayed on the second digital mirror display device 202b (the right side view digital mirror display device), the digital mirror display monitoring system 100 issues a command to the infotainment display device 208 to cease display of the external images associated with the second digital mirror display device 202b (the right side view digital mirror display device) on the infotainment display device 208. In at least one embodiment, in the case of a successful reboot, the infotainment display device 208 displays an issue resolved notification.

If the digital mirror display monitoring system 100 determines that the reboot of the second digital mirror display device 202b (the right side view digital mirror display device) did not result in an external image of captured by the second external camera 200b matching a display of a corrected image of a right side view digital mirror display displayed on the second digital mirror display device 202b (the right side view digital mirror display device), the digital mirror display monitoring system 100 issues a command to shut down the second digital mirror display device 202b (the right side view digital mirror display device). The second digital mirror display device 202b (the right side view digital mirror display device) shuts down in response to the command to shut down the second digital mirror display device 202b (the right side view digital mirror display device). In at least one embodiment, in the case of an unsuccessful reboot, the infotainment display device 208 displays a rear view monitor system needs service notification.

While the operation of the digital mirror display monitoring system 100 has been described with reference to a left side view digital mirror display device and a right side view digital mirror display device, the digital mirror display monitoring system 100 may be used to identify image mismatches between other types of digital mirror display devices 202.

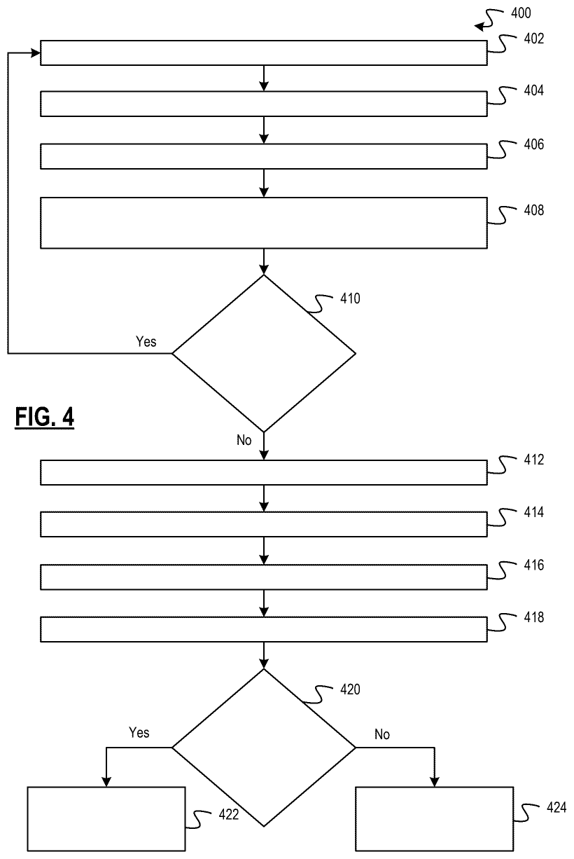

Referring to FIG. 4, a flowchart representation of an exemplary method 400 of monitoring a digital mirror display in a vehicle 10 in accordance with at least one embodiment is shown. The method 400 will be described with reference to an exemplary implementation of an embodiment of a digital mirror display monitoring system 100. As can be appreciated in light of the disclosure, the order of operation within the method 400 is not limited to the sequential execution as illustrated in FIG. 4 but may be performed in one or more varying orders as applicable and in accordance with the present disclosure.

At 402, an external image of an environment outside a vehicle 10 from a perspective of a vehicle mirror view of the vehicle 10 captured by an external camera 200 is received at the digital mirror display monitoring system 100 in real time. The external camera 200 is associated with a digital mirror display device 202. The digital mirror display device 202 displays the external image captured by the external camera 200 as a digital mirror display.

At 404, an internal image of an in-cabin environment inside the vehicle 10 captured by an internal camera 204 is received at the digital mirror display monitoring system 100 in real time. The internal image includes an image of the digital mirror display displayed on the digital mirror display device 202.

At 406, the internal image is cropped by the digital mirror display monitoring system 100 to generate an ROI of the internal image. The ROI of the internal image is the image of the digital mirror display displayed on the digital mirror display device 202. At 408, distortion correction of the ROI is implemented by the digital mirror display monitoring system 100 to generate a corrected image of the digital mirror display.

At 410, the digital mirror display monitoring system 100 determines whether the external image matches the image of the corrected image of the digital mirror display. The digital mirror display monitoring system 100 employs a trained DNN model to compare the external image with the corrected image of the digital mirror display. The trained DNN model generates a first set of features based on the external image and a second set of features based on the corrected image of the digital mirror display. The trained DNN model generates a first vector based on the first set of features based on the external image and a second vector based on the second set of features based on the corrected image of the digital mirror display. The trained DNN model determines whether the external image matches the image of the corrected image of the digital mirror display based on a comparison of the first vector based on the external image with the second vector based on the image of the corrected image of the digital mirror display.

If the digital mirror display monitoring system 100 determines that the external image matches the image of the corrected image of the digital mirror display, the method returns to 402. If the digital mirror display monitoring system 100 determines that the external image does not match the image of the corrected image of the digital mirror display, the digital mirror display monitoring system 100 identifies an image mismatch cause associated with the digital mirror display on the digital mirror display device 202 at 412. Examples of causes of the image mismatch include, but are not limited to, a digital mirror display freeze, a digital mirror display color fade, and black pixel detection in the digital mirror display.

At 414, the digital mirror display monitoring system 100 generates an image mismatch notification for display on a vehicle display device 206. At 416, the digital mirror display monitoring system 100 transmits the external images received from the external camera 200 associated with the digital mirror display device 202 to an infotainment display device 208 for display at the infotainment display device 208.

At 418, the digital mirror display monitoring system 100 reboots the digital mirror display device 202 associated with the image mismatch. At 420, the digital mirror display monitoring system 100 determines whether the reboot of the digital mirror display device 202 resulted in the external image matching the corrected image of the digital mirror display.

If the digital mirror display monitoring system 100 determines that the reboot of the digital mirror display device 202 resulted in the external image matching the corrected image of the digital mirror display, the digital mirror display monitoring system 100 issues a command to the infotainment display device 208 to cease display of the image mismatch notification on the infotainment display device 208 at 422. In at least one embodiment, if the digital mirror display monitoring system 100 determines that the reboot of the digital mirror display device 202 resulted in the external image matching the corrected image of the digital mirror display, the digital mirror display monitoring system 100 issues a command to the infotainment display device 208 to cease display of the external images on the infotainment display device 208.

If the digital mirror display monitoring system 100 determines that the reboot of the digital mirror display device 202 did not result in the external image matching the corrected image of the digital mirror display, the digital mirror display monitoring system 100 issues a command to digital mirror display device 202 to shut down at 424.

In at least one embodiment, external images received from an external camera 200 are modified in accordance with a color deficient driver setting to generate modified external images. The digital mirror display device 202 displays the modified external images. The digital mirror display monitoring system 100 determines whether an external image received from the external camera 200 associated with a digital mirror display device 202 matches a digital mirror display displayed on the digital mirror display device 202 by comparing the modified external image with the image of the digital mirror display. The digital mirror display monitoring system 100 generates the image mismatch notification associated with the digital mirror display device 202 for display on a vehicle display device 206 based on the determination.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A digital mirror display monitoring system for a vehicle, comprising:
at least one processor; and
at least one memory communicatively coupled to the at least one processor, the at least one memory comprising instructions that upon execution by the at least one processor, causes the at least one processor to:
receive an external image captured by a first camera system of the vehicle, the external image comprising a perspective of a vehicle mirror view of an external environment outside of the vehicle;
receive an internal image captured by a second camera system of the vehicle, the internal image comprising an in-cabin environment inside the vehicle, wherein the internal image comprises an image of a digital mirror display inside the vehicle and the digital mirror display is generated based on the external image;
determine whether the external image matches the image of the digital mirror display; and
generate an image mismatch notification for display on a vehicle display device of the vehicle based on the determination.

2. The system of claim 1, wherein the at least one memory further comprises instructions that upon execution by the at least one processor, causes the at least one processor to:
crop the internal image to generate a region of interest (ROI) of the internal image associated with the image of the digital mirror display;
implement distortion correction of the ROI of the internal image to generate a corrected image of the digital mirror display; and
determine whether the external image matches the image of the digital mirror display based on a comparison of the external image with the corrected image of the digital mirror display.

3. The system of claim 2, wherein the at least one memory further comprises instructions that upon execution by the at least one processor, causes the at least one processor to use a trained deep neural network (DNN) model to:
generate a first set of features based on the external image;
generate a first vector based on the first set of features;
generate a second set of features based on the corrected image of the digital mirror display;
generate a second vector based on the second set of features; and
determine whether the external image matches the corrected image of the digital mirror display based on a comparison of the first vector to the second vector.

4. The system of claim 3, wherein the DNN is classifier DNN.

5. The system of claim 1, wherein the at least one memory further comprises instructions that upon execution by the at least one processor, causes the at least one processor to upon a determination that the external image does not match the image of the digital mirror display, identify an image mismatch cause associated with the digital mirror display, the image mismatch cause being one of a digital mirror display freeze, a digital mirror display color fade, and black pixel detection in the digital mirror display.

6. The system of claim 1, wherein the at least one memory further comprises instructions that upon execution by the at least one processor, causes the at least one processor to upon a determination that the external image does not match the image of the digital mirror display, transmit the external image to an infotainment display device of the vehicle for display on the infotainment display device.

7. The system of claim 6, wherein the at least one memory further comprises instructions that upon execution by the at least one processor, causes the at least one processor to:
reboot a digital mirror display device configured to display the digital mirror display;
determine whether the reboot of the digital mirror display device resulted in the external image matching the image of the digital mirror display; and
issue a command to the infotainment display device to cease display of the external image on the infotainment vehicle display device based on the determination.

8. The system of claim 7, wherein the at least one memory further comprises instructions that upon execution by the at least one processor, causes the at least one processor to upon a determination that the reboot of the digital mirror display device did not result in the external image matching the image of the digital mirror display, issue a command to shut down the digital mirror display device.

9. The system of claim 1, wherein the digital mirror display device is a side view digital mirror display device of the vehicle.

10. The system of claim 1, wherein the at least one memory further comprises instructions that upon execution by the at least one processor, causes the at least one processor to:
modify at least one color in the external image in accordance with a color deficient driver setting to generate a modified external image;
issue a command to a digital mirror display device to display the digital mirror display based on the modified external image;
determine whether the modified external image matches the image of the digital mirror display; and
generate the digital mirror display device mismatch notification for display on the vehicle display device based on the determination.

11. A method of monitoring a digital mirror display comprising:
receiving, at a controller, an external image captured by a first camera system of the vehicle, the external image comprising a perspective of a vehicle mirror view of an external environment outside of the vehicle;
receiving, at the controller, an internal image captured by a second camera system of the vehicle, the internal image comprising an in-cabin environment inside the vehicle, wherein the internal image comprises an image of a digital mirror display inside the vehicle and the digital mirror display is generated based on the external image;
determining, by the controller, whether the external image matches the image of the digital mirror display; and
generating, by the controller, an image mismatch notification for display on a vehicle display device of the vehicle based on the determination.

12. The method of claim 11, further comprising:
cropping, by the controller, the internal image to generate a region of interest (ROI) of the internal image associated with the image of the digital mirror display;
implementing, by the controller, distortion correction of the ROI of the internal image to generate a corrected image of the digital mirror display; and
determining, by the controller, whether the external image matches the image of the digital mirror display based on a comparison of the external image with the corrected image of the digital mirror display.

13. The method of claim 12, further comprising using, by the controller, a trained deep neural network (DNN) model to:
generate a first set of features based on the external image;
generate a first vector based on the first set of features;
generate a second set of features based on the corrected image of the digital mirror display;
generate a second vector based on the second set of features; and
determine whether the external image matches the corrected image of the digital mirror display based on a comparison of the first vector to the second vector.

14. The method of claim 11, further comprising upon a determination that the external image does not match the image of the digital mirror display, identifying, by the controller, an image mismatch cause associated with the digital mirror display, the image mismatch cause being one of a digital mirror display freeze, a digital mirror display color fade, and black pixel detection in the digital mirror display.

15. The method of claim 11, further comprising upon a determination that the external image does not match the image of the digital mirror display, transmitting, by the controller, the external image to an infotainment display device of the vehicle for display on the infotainment display device.

16. The method of claim 15, further comprising:
rebooting, by the controller, a digital mirror display device configured to display the digital mirror display;
determining, by the controller, whether the reboot of the digital mirror display device resulted in the external image matching the image of the digital mirror display; and
issuing a command, by the controller, to the infotainment display device to cease display of the external image on the infotainment vehicle display device based on the determination.

17. The method of claim 16, further comprising upon a determination that the reboot of the digital mirror display device did not result in the external image matching the image of the digital mirror display, issuing, by the controller, a command to shut down the digital mirror display device.

18. The method of claim 11, wherein the digital mirror display device is a side view digital mirror display device of the vehicle.

19. The method of claim 11, further comprising:
modifying, by the controller, at least one color in the external image in accordance with a color deficient driver setting to generate a modified external image;
issuing a command, by the controller, to a digital mirror display device to display the digital mirror display based on the modified external image;
determining, by the controller, whether the modified external image matches the image of the digital mirror display; and
generating, by the controller, the digital mirror display device mismatch notification for display on the vehicle display device based on the determination.

20. A vehicle including a digital mirror display monitoring system comprising:
at least one processor; and
at least one memory communicatively coupled to the at least one processor, the at least one memory comprising instructions that upon execution by the at least one processor, causes the at least one processor to:
receive an external image captured by a first camera system of the vehicle, the external image comprising a perspective of a vehicle mirror view of an external environment outside of the vehicle;
receive an internal image captured by a second camera system of the vehicle, the internal image comprising an in-cabin environment inside the vehicle, wherein the internal image comprises an image of a digital mirror display inside the vehicle and the digital mirror display is generated based on the external image;
determine whether the external image matches the image of the digital mirror display; and
generate an image mismatch notification for display on a vehicle display device of the vehicle based on the determination.
